(19) United States
(12) Patent Application Publication
(10) Pub. No.: US 2021/0132218 A1
(43) Pub. Date: May 6, 2021

(54) MAKING WEATHER INFORMATION AVAILABLE DURING BAD WEATHER

(71) Applicant: Scott Drummond, Tuscaloosa, AL (US)

(72) Inventor: Scott Drummond, Tuscaloosa, AL (US)

(21) Appl. No.: 17/089,313

(22) Filed: Nov. 4, 2020

Related U.S. Application Data
(60) Provisional application No. 62/930,037, filed on Nov. 4, 2019.

(51) Int. Cl. G01S 13/95; G06F 16/29; H04W 4/90; G01W 1/00

(52) U.S. Cl. CPC G01S 13/95; G01W 1/00; H04W 4/90; G06F 16/29

(57) ABSTRACT

Systems and methods may be used to provide radar data before, during, or after an emergency, such as a weather emergency. An example method may include downloading radar data, at a device, saving the radar data to memory of the device, identifying that a network outage has occurred (e.g., for a network connection of the device), and causing information related to the retrieved radar data to be displayed.

### CLAIM OF PRIORITY

This application claims the benefit of priority to U.S. Provisional Applications No. 62/930,037, filed Nov. 4, 2019, titled “SYSTEM AND METHOD FOR MAKING WEATHER INFORMATION AVAILABLE DURING BAD WEATHER”; which is hereby incorporated herein by reference in its entirety.

### BACKGROUND

Weather or radar data can be essential for understanding current weather threats such as tornados, thunderstorms, hurricanes, or snowstorms. Radar is used to detect rain or other precipitation and its track movement. A radar station sends out pulses that are reflected back, and the reflection is measured by the radar station to determine where the precipitation is occurring. Raw information received at the radar station can be converted into different visual displays of radar data for understanding weather patterns, movement, and types.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a weather radar communication system in accordance with some embodiments.

FIG. 2 illustrates an example display screen for providing weather information in accordance with some embodiments.

FIG. 3 illustrates a flowchart showing a technique for providing radar information in accordance with some embodiments.

FIG. 4 illustrates generally an example of a block diagram of a machine upon which any one or more of the techniques discussed herein may perform in accordance with some embodiments.

### DETAILED DESCRIPTION

Systems and methods described herein provide radar data to be displayed on a display screen in response to a network failure. For example, a cell phone or television (e.g., a smart tv) may continuously load or store radar data in the background. This radar data may be referenced during times of internet or tv outage (or other network outage, such as a power outage). An app may run on a tv or mobile device (e.g., cell phone or tablet), and the radar data may be displayed automatically when the network outage occurs. For example, a tv or a cable provider may cause the radar data to be shown on a screen when service is interrupted.

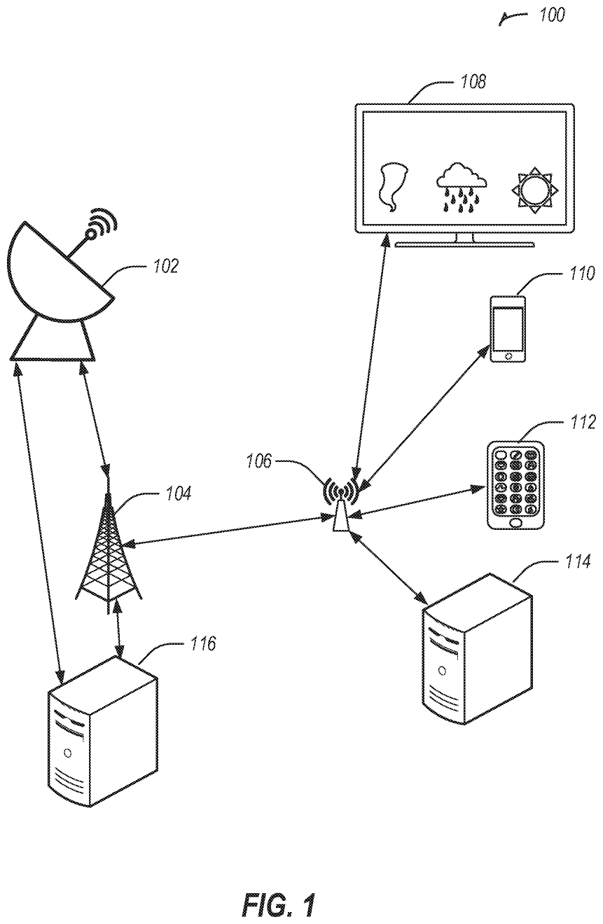

FIG. 1 illustrates a weather radar communication system 100 in accordance with some embodiments. The system 100 may include a radar station 102, connection devices 104-106, and one or more end user devices 108-114. The connection devices may include a communication antenna 104 or an access point 106, as well as other connection devices not shown. The end user devices may include a television 108 (e.g., a smart television including a processor and memory, such as one configured to run an application), a mobile device, such as a cell phone 110 or a tablet 112, or a computer (e.g., a laptop or desktop) 114.

In an example, the radar station 102 obtains radar data, for example doppler radar, weather information, etc. The radar data may include results of algorithms or techniques to refine raw radar information. For example, radar data may include a visual representation of raw data. The radar data may be sent from the radar station 102 to a communication antenna 104, for forwarding to an end user device (e.g., 108-114).

An end user device (e.g., 108-114) may download radar data, for example automatically in a background process. The background process may be opaque to a user (e.g., not actively involving the user). For example, a user may set up a device to download radar data in the background, which may then be automatically downloaded. In another example, a device may come preconfigured with an application to automatically download radar data.

The end user device (e.g., 108-114) may be configured to detect or be notified that a network outage has occurred (e.g., an internet outage, a television network outage, a power outage, or the like). In response to the network outage occurring, the end user device (e.g., 108-114) may display previously downloaded radar data. For example, radar data from the previous 30 minutes may be displayed in a loop. In another example, a still image of radar data may be displayed. A storm type (e.g., tornado, thunderstorm, hurricane, snowstorm, etc.) may be displayed. In an example, downloaded radar data may be sent from one end user device (e.g., 108-114) to another, or may be downloaded onto multiple devices.

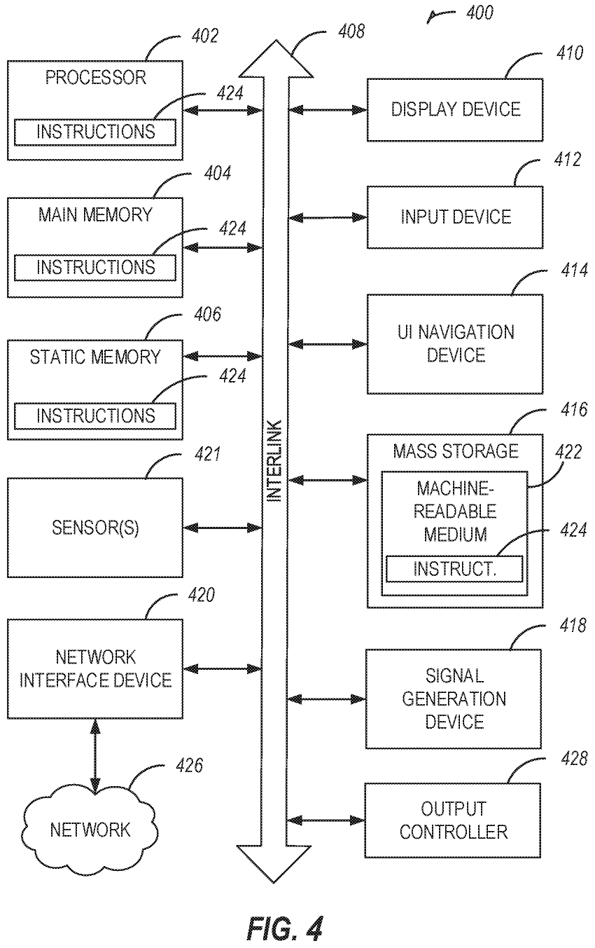

In an example, any of the end user devices 108-114 may include a display screen, network interface circuitry, a processor, or memory. The network interface circuitry may include wireless networking circuitry or a wired networking circuitry (e.g., a network interface card). The memory may store instructions for execution by the processor. Further example details of end user devices 108-114 are described below with respect to FIG. 4.

FIG. 1 further illustrates a server 116, remote from the end user devices 108-114. The server 116 may be in communication with the communication antenna 104, such as to receive data from the radar station 102 or one of the end user devices 108-114. In an example, the server 116 is located with the radar station 102 (e.g., a physical station includes both an antenna and the server 116). In another example, the radar station 102 and the server 116 communicate using a network connection other than the communication antenna 104.

In an example, the server 116 (or any other computing device of FIG. 1, such as the computer 114) may be used to generate a machine learning model related to input radar data, weather conditions, network connectivity historical data, or seasonal variation. Once generated, the machine learning model may be deployed to run on one of the end user devices 108-114. The deployed model may be personalized to the particular end user device 108-114, to a user of the end user device 108-114, to a location of the end user device 108-114, to previously received radar data at the end user device 108-114, to previous network outage data, or the like. In an example, the deployed model may be run to output a prediction, such as such as a predicted path of a weather-related event (e.g., a storm, a tornado, a hurricane, etc.), predicted damage or danger (e.g., from a weather-related event), predicted down time for a network having the outage, traffic patterns (e.g., affected by the weather-related event, such as road flooding), or the like.

Machine learning may use a training engine and an estimation engine. A training engine inputs historical transaction information (e.g., past weather events, past network outages, past power outages, past paths of weather events, timing for return of past outages, or the like) into a feature determination engine. The historical action information may be labeled, for example with outputs such as whether a weather event caused damage to an area, whether a network outage occurred, whether power was lost, whether users were left without sufficient information, or the like.

A feature determination engine may determine one or more features from this historical information. Stated generally, features may include a set of the information input and include information determined to be predictive of a particular outcome. The features may be determined by hidden layers, in an example. A machine learning algorithm produces a model based on the features and the labels.

In the estimation engine, current action information (e.g., current weather status, current network status, etc.) may be input to the estimation feature determination engine. The estimation feature determination engine may determine features of the current information to estimate an output (e.g., predict a likelihood of a weather event causing damage, predict whether a network outage is likely to occur, predict whether a path of a weather event includes a user's location, predict a likelihood that a power outage will occur, or the like). In some examples, feature determination engines in training and estimation may be the same engine. The feature determination engine in the estimation produces a feature vector, which is input into the model to generate one or more criteria weightings. The training engine may operate in an offline manner, online manner, or hybrid (e.g., partially trained offline, then completed online) to train the model. The estimation engine may be designed to operate in an online manner, in some examples. It should be noted that the model may be periodically updated via additional training or user feedback (e.g., additional, changed, or removed measurements or patient states).

The machine learning algorithm may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not require a training engine.

In an example, predictive data may be output using the model, including likelihood of other network service outages (e.g., landline, cell phone, power, television, internet, etc.).

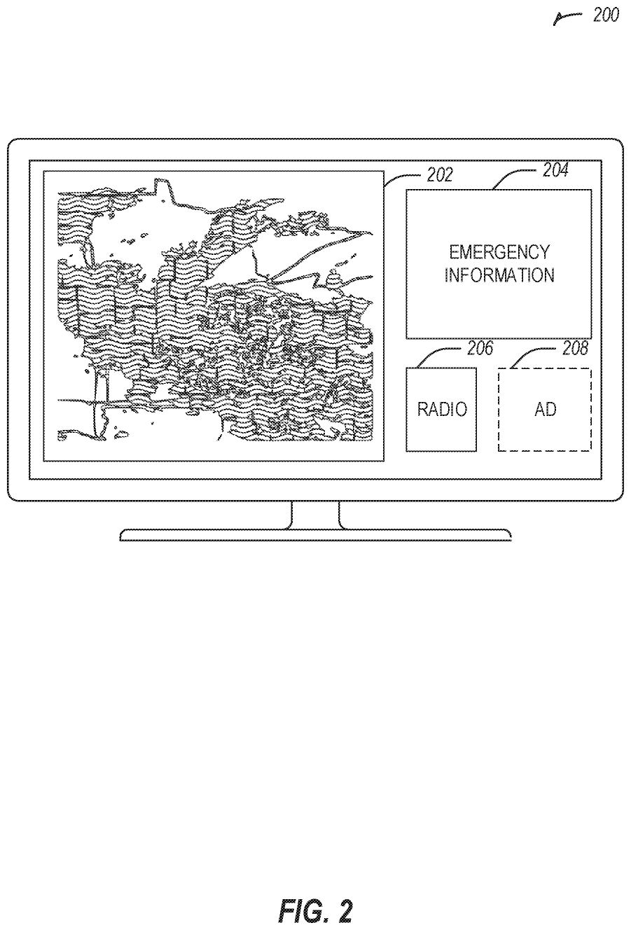

FIG. 2 illustrates an example display screen 200 for providing weather information in accordance with some embodiments.

The display screen 200 is depicted as a television, but may be a mobile device (e.g., a cell phone, a tablet, a smartwatch, etc.) or other display screen. The display screen 200 includes a visual depiction 202 of radar data. Additional information may be optionally presented, such as emergency information 204, radio information 206, or an advertisement 208.

The visual depiction 202 may be based on previously downloaded radar data (e.g., before a network outage). The visual depiction 202 may be displayed on the display screen 200 automatically in response to detection of a network outage.

The emergency information 204 may include a weather type (e.g., hail, snow, wind, tornado, earthquake, hurricane, rain, etc.). The emergency information 204 may include specific warnings for a zip code, county, city, or other location. The emergency information 204 may include safety instructions, such as “move to a lowest floor in an interior room” in the case of a tornado, for example.

The radio information 206 may include a user interface component or may include an audio-only component without a visual component. Radio may be played (e.g., a FM or AM weather station) automatically or based on a user selection (e.g., using a touchscreen tap or a television remote).

The display screen 200 may optionally include an advertisement 208. The advertisement 208 may be related to weather or disaster preparedness, in an example. The advertisement 208 may be an unobtrusive ad, for example placed in a corner of the display screen 200 or taking up less room on the display screen 200 than another component or all components. The advertisement 208 may be downloaded in a background process along with or in parallel with the radar data. The advertisement 208 may be dismissed by a user in an example, and removed from the display screen 200 in response.

In an example, the advertisement 208 may be displayed in response to a trigger. The trigger may include a network outage (e.g., the network outage that triggers display of the visual depiction 202 of radar data, or a different network outage), a user interaction with a device or the display screen 200 (e.g., a user selecting or activating the visual depiction 202, the emergency information 204, or the radio 206, changing volume of a component or device, using a voice command, or the like), a change in weather or radar data (e.g., an update to radar data), etc. The advertisement 208 may be generated to correspond to an aspect of the display screen 200, such as being related to radar data displayed in the visual depiction 202, related to location of the display screen 200 (e.g., a state, country, county, etc.), related to audio playing on the radio 206 (e.g., synced with a radio ad, for example), or the like. The advertisement 208 may be presented in an unobtrusive format, such as in a corner of the display screen 200, as a banner on a side, top, or bottom of the display screen 200, or the like. In some examples, the advertisement 208 may be configured to be closeable by a user selection. Additional data related to the advertisement 208 may be stored locally (e.g., downloaded when the advertisement 208 is downloaded), such as a website, a phone number, an address, or an email address corresponding to content of the advertisement 208, additional content, such as a video, audio, or image file, or the like.

A set of advertisement may be predownloaded (e.g., before a network outage occurs, such as during normal operation of the display screen 200, or when the radar data displayed in the visual depiction 202 is downloaded). The advertisement 208 may be opt in, such as by opting into receiving cached radar data to be displayed during a network outage. When multiple advertisements are available, the advertisements may be periodically cycled (sequentially or arbitrarily) or refreshed. In other examples, the advertisement 208 may display only a single advertising content to reduce power usage (e.g., only a static image may be displayed, limiting processor usage during the network outage). Changing among advertisements may be dynamic, such as based on available power and network availability. For example, when power is supplied by a backup power (e.g., a generator or battery), the advertisement may remain constant to avoid additional burden on the power source. In another example, when a network outage is a television outage, but an internet or other network connection allows data to be transferred between the device and a remote device, the advertisement 208 may be changed periodically.

Other components of the display screen 200 may be dynamically displayed or updated as well. For example, the visual depiction 202 may display a static image of radar data (e.g., last available data) when power is supplied by a generator or battery. When normal power is available, the visual depiction 202 may display an animation or video of radar data over a period of time. In some examples, display aspects of the components may be selectable by a user (e.g., a user may select whether to view radar data as a static image or dynamic video or images in the visual depiction 202).

In an example, the advertisement 208 may include a selectable component. The selectable component may cause an event to occur. In some examples, the event may be time delayed (e.g., stored and activated when a network connection is restored). The event may include initiating a request for more information (e.g., to be emailed, mailed, texted, or called to the user), accessing a website, etc. In an example, the advertisement 208 may be changed based on interactions with the visual depiction 202, the emergency information 204, or the radio 206. For example, the advertisement 208 may be synced to the radio 206 when the radio 206 is activated, or desynced when the radio 206 is deactivated. The advertisement 208 may be changed when a location viewed for the radar data changes the visual depiction 202 (e.g., zooms in or out, corresponding to a more local or a less local advertisement). The advertisement 208 may be changed when the emergency information 204 is interacted with by a user, such as by changing to an official advertisement (e.g., a government sponsored advertisement).

Similarly, the other components of the display screen may be changed based on user interaction with any one or more components. For example, the radio 206 may be silenced when a user interacts with the emergency information 204 (e.g., when a user selects to hear text to voice or audio of the emergency information component 204).

When a network outage occurs, the display screen 200 may enter a troubleshooting configuration with a troubleshooting or message user interface. The user interface may include an option to view radar data, or may directly display the visual depiction 202 automatically.

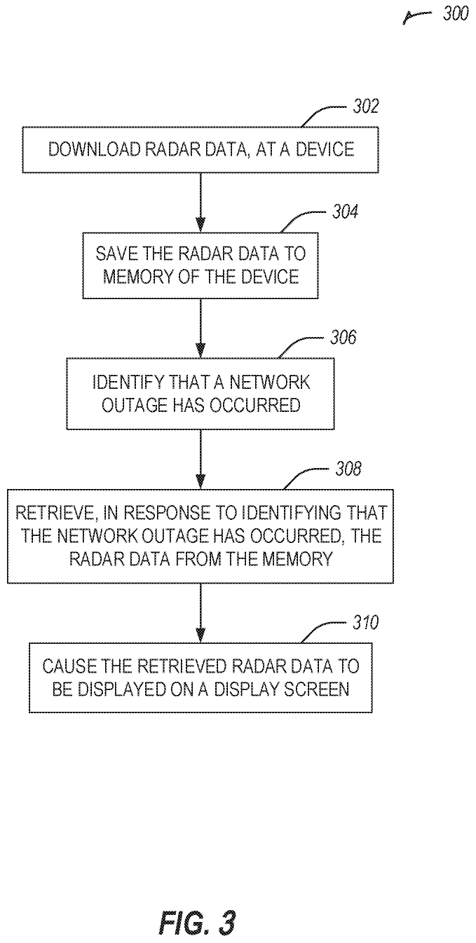

FIG. 3 illustrates a flowchart showing a technique 300 for providing radar information in accordance with some embodiments.

The technique 300 includes an operation 302 to download radar data, at a device. The device may include a smart television, a cell phone (or other mobile device, e.g., a tablet), a computer, or the like. In an example, the radar data may be downloaded using a background process opaque to a user (e.g., once activated by the user in an opt in, or automatically without needing an opt in, the radar data may be downloaded automatically in the background without showing the user or requiring user action; the radar data may be displayed without user action automatically, in an example, when a network outage occurs). The radar data may be downloaded by the device periodically, without user input or without displaying any indication that the radar data has been downloaded.

The technique 300 includes an operation 304 to save the radar data to memory of the device. In an example, operation 302 includes periodically updating the radar data saved in the memory. In an example, operation 302 includes intermittently sending downloaded radar data to a second device (e.g., a cell phone) that is not affected by a power outage.

The technique 300 includes an operation 306 to identify that a network outage has occurred. The network outage may include a television network outage, an internet outage, or a power outage. In an example, the network outage includes a power outage that causes the device to lose primary power. In this example, the technique 300 may include drawing power from a battery backup for the device to display the retrieved radar data or sending the radar data to a remote device for display. In another example, the technique 300 may include determining that a power outage has occurred that causes the device to lose primary power (or backup power), and in response, displaying the retrieved radar data at a second device. The second device may monitor a power status of the device, such as in response to receiving an indication from the device that the network outage has occurred. In some examples, the network outage may correspond to a network connection of the device. In other example, the network outage may not correspond to a network connection of the device, but instead to a remote network connection, such as a relay, or a network outage from a server or device supplying the radar data.

The technique 300 includes an operation 308 to retrieve, in response to identifying that the network outage has occurred, the radar data from the memory. Operation 308 may include directing a secondary device to retrieve the radar data from the memory. The memory may be on the device or remote from the device.

The technique 300 includes an operation 310 to cause the retrieved radar data to be displayed on a display screen. The display screen may be a screen of the device or a screen remote from the device. The display screen may be a screen of a smart tv, a tablet, a cell phone, etc. The radar data may be sent to a remote device using a Bluetooth or WiFi connection, for example, without an internet connection. Instead of, or in addition to, causing the retrieved radar data to be displayed, operation 310 may include causing information corresponding to the retrieved radar data to be displayed.

This information may include data related to a weather-related event such as a predicted path of a storm, tornado, or hurricane. This information may include predicted information (e.g., generated via a machine learning model), such as the predicted path, predicted damage or danger, predicted down time for the network having the outage, or the like. This information may include an alert (e.g., indicating potential danger or damage from an emergency, such as damaging winds or hail), traffic information (e.g., a change in traffic pattern due to flooding), an emergency declaration, or the like. The alert may be sent out, such as to friends or family, to a local power company, or to a civil defense alert system.

In an example, in response to identifying that the network outage has occurred, the technique 300 may include displaying a storm type on the display screen, for example, a thunderstorm, a tornado, a hurricane, a snowstorm, or the like.

FIG. 4 illustrates generally an example of a block diagram of a machine 400 upon which any one or more of the techniques (e.g., methodologies) discussed herein may perform in accordance with some embodiments. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example, the display unit 410, alphanumeric input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 that is non-transitory on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 400, and includes digital or analog communications signals or other intangible medium to facilitate communication of such software.

Example 1 is a method for providing radar data in an emergency, the method comprising: downloading radar data, at a device; saving the radar data to memory of the device; identifying that a network outage has occurred; retrieving, in response to identifying that the network outage has occurred, the radar data from the memory; and causing the retrieved radar data to be displayed on a display screen during the network outage.

In Example 2, the subject matter of Example 1 includes, wherein the device is a smart television.

In Example 3, the subject matter of Examples 1-2 includes, wherein downloading the radar data includes periodically updating the radar data saved in the memory.

In Example 4, the subject matter of Examples 1-3 includes, wherein the network outage is a television network outage.

In Example 5, the subject matter of Examples 1-4 includes, wherein the network outage is an internet outage.

In Example 6, the subject matter of Examples 1-5 includes, wherein the display screen is remote from the device.

In Example 7, the subject matter of Example 6 includes, wherein the display screen is a screen of a tablet or a mobile device wirelessly connected to the device.

In Example 8, the subject matter of Examples 1-7 includes, determining that a power outage has occurred that causes the device to lose primary power, and further comprising drawing power from a battery backup for the device to cause the retrieved radar data to be displayed.

In Example 9, the subject matter of Examples 1-8 includes, in response to identifying that the network outage has occurred, connecting to an FM radio station to output weather information.

In Example 10, the subject matter of Examples 1-9 includes, in response to identifying that the network outage has occurred, displaying a storm type on the display screen, the storm type including at least one of a thunderstorm, a tornado, a hurricane, or a snowstorm.

In Example 11, the subject matter of Examples 1-10 includes, wherein the radar data is downloaded using a background process opaque to a user.

In Example 12, the subject matter of Examples 1-11 includes, wherein the network outage corresponds to a network connection of the device.

In Example 13, the subject matter of Examples 1-12 includes, determining, at a second device connected to the device, that the device has lost power, and in response, displaying, at the second device, the retrieved radar data.

Example 14 is a device for providing radar data in an emergency, the method comprising: a display screen; a network interface circuitry; a processor; and memory, including instructions, which when executed, cause the processor to perform operations comprising: downloading radar data; saving the radar data to the memory of the device; identifying, via the network interface circuitry, that a network outage has occurred for a network connection of the network interface circuitry; retrieving, in response to identifying that the network outage has occurred, the radar data from the memory; and causing information corresponding to the retrieved radar data to be displayed on the display screen during the network outage.

In Example 15, the subject matter of Example 14 includes, wherein the device is a smart television.

In Example 16, the subject matter of Examples 14-15 includes, wherein downloading the radar data includes periodically updating the radar data saved in the memory.

In Example 17, the subject matter of Examples 14-16 includes, wherein the instructions, when executed, further cause the processor to perform operations comprising determining that a power outage has occurred that causes the device to lose primary power, and drawing power from a battery backup for the device to cause the information corresponding to the retrieved radar data to be displayed.

In Example 18, the subject matter of Examples 14-17 includes, wherein the information corresponding to the retrieved radar data includes an alert indicating potential danger from the emergency.

In Example 19, the subject matter of Examples 14-18 includes, wherein causing the information corresponding to the retrieved radar data to be displayed includes causing a predicted path of a weather-related event to be displayed.

Example 20 is at least one machine-readable medium including instructions for providing radar data in an emergency, which when executed by a processor, cause the processor to perform operations comprising: downloading radar data from a radar service; saving the radar data to memory; identifying that a network outage has occurred for a network connection used to download the radar data; retrieving, in response to identifying that the network outage has occurred, the radar data from the memory; and causing information corresponding to the retrieved radar data to be displayed on a display screen during the network outage.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method for providing radar data in an emergency, the method comprising:
downloading radar data, at a device;
saving the radar data to memory of the device;
identifying that a network outage has occurred;
retrieving, in response to identifying that the network outage has occurred, the radar data from the memory; and
causing the retrieved radar data to be displayed on a display screen during the network outage.

2. The method of claim 1, wherein the device is a smart television.

3. The method of claim 1, wherein downloading the radar data includes periodically updating the radar data saved in the memory.

4. The method of claim 1, wherein the network outage is a television network outage.

5. The method of claim 1, wherein the network outage is an internet outage.

6. The method of claim 1, wherein the display screen is remote from the device.

7. The method of claim 6, wherein the display screen is a screen of a tablet or a mobile device wirelessly connected to the device.

8. The method of claim 1, further comprising determining that a power outage has occurred that causes the device to lose primary power, and further comprising drawing power from a battery backup for the device to cause the retrieved radar data to be displayed.

9. The method of claim 1, further comprising, in response to identifying that the network outage has occurred, connecting to an FM radio station to output weather information.

10. The method of claim 1, further comprising, in response to identifying that the network outage has occurred, displaying a storm type on the display screen, the storm type including at least one of a thunderstorm, a tornado, a hurricane, or a snowstorm.

11. The method of claim 1, wherein the radar data is downloaded using a background process opaque to a user.

12. The method of claim 1, wherein the network outage corresponds to a network connection of the device.

13. The method of claim 1, further comprising determining, at a second device connected to the device, that the device has lost power, and in response, displaying, at the second device, the retrieved radar data.

14. A device for providing radar data in an emergency, the device comprising:
a display screen;
a network interface circuitry;
a processor; and
memory, including instructions, which when executed, cause the processor to perform operations comprising:
downloading radar data;
saving the radar data to the memory of the device;
identifying, via the network interface circuitry, that a network outage has occurred for a network connection of the network interface circuitry;
retrieving, in response to identifying that the network outage has occurred, the radar data from the memory; and
causing information corresponding to the retrieved radar data to be displayed on the display screen during the network outage.

15. The device of claim 14, wherein the device is a smart television.

16. The device of claim 14, wherein downloading the radar data includes periodically updating the radar data saved in the memory.

17. The device of claim 14, wherein the instructions, when executed, further cause the processor to perform operations comprising determining that a power outage has occurred that causes the device to lose primary power, and drawing power from a battery backup for the device to cause the information corresponding to the retrieved radar data to be displayed.

18. The device of claim 14, wherein the information corresponding to the retrieved radar data includes an alert indicating potential danger from the emergency.

19. The device of claim 14, wherein causing the information corresponding to the retrieved radar data to be displayed includes causing a predicted path of a weather-related event to be displayed.

20. At least one machine-readable medium including instructions for providing radar data in an emergency, which when executed by a processor, cause the processor to perform operations comprising:
downloading radar data from a radar service;
saving the radar data to memory;
identifying that a network outage has occurred for a network connection used to download the radar data;
retrieving, in response to identifying that the network outage has occurred, the radar data from the memory; and
causing information corresponding to the retrieved radar data to be displayed on a display screen during the network outage.
